(19) United States
(12) Patent Application Publication
(10) Pub. No.: US 2022/0405489 A1
(43) Pub. Date: Dec. 22, 2022

(54) FORMULATING NATURAL LANGUAGE DESCRIPTIONS BASED ON TEMPORAL SEQUENCES OF IMAGES

(71) Applicant: X Development LLC, Mountain View, CA (US)

(72) Inventors: Rebecca Radkoff, San Francisco, CA (US); David Andre, San Francisco, CA (US)

(21) Appl. No.: 17/706,844

(22) Filed: Mar. 29, 2022

Related U.S. Application Data
(60) Provisional application No. 63/213,443, filed on Jun. 22, 2021.

(51) Int. Cl. G06F 40/56; G06F 40/35; G06V 20/40

(52) U.S. Cl. CPC G06F 40/56; G06F 40/35; G06V 20/41

(57) ABSTRACT

Implementations are described herein for formulating natural language descriptions based on temporal sequences of digital images. In various implementations, a natural language input may be analyzed. Based on the analysis, a semantic scope to be imposed on a natural language description that is to be formulated based on a temporal sequence of digital images may be determined. The temporal sequence of digital images may be processed based on one or more machine learning models to identify one or more candidate features that fall within the semantic scope. One or more other features that fall outside of the semantic scope may be disregarded. The natural language description may be formulated to describe one or more of the candidate features.

### BACKGROUND

Textual data may be generated based on a video feed for a variety of reasons. Video captioning or transcription is the process of transcribing dialog spoken in a video into textual subtitles. Subtitles can be presented in temporal synchronization with the video feed so that, for instance, hearing-impaired individuals are able to perceive the dialog. Video description or summarization, by contrast, may include generating a natural language description of event(s) that are visually perceptible in a video feed (although this does not exclude also transcribing dialog for subtitles). Historically, video classification has been a time-consuming and laborious process. Recent advances with statistical techniques and machine learning have streamlined the video classification process somewhat. However, these solutions still suffer from various drawbacks, such as not being scalable across distinct domains, and being inflexible in highly-unpredictable and/or complex scenarios.

### SUMMARY

Implementations are described herein for formulating reduced-dimensionality semantic representations, such as natural language descriptions, based on temporal sequences of digital images. More particularly, but not exclusively, techniques are described herein for learning mappings between different semantic spaces (also referred to herein as “embedding spaces”), such as natural language semantic space, other more structured semantic spaces, and visual semantic space(s) associated with video streams in various domains. Those mappings may be used to not only generate reduced-dimensionality semantic representations, such as natural language descriptions, of temporal sequences of digital images, but to impose a semantic scope on the generated natural language description. Consequently, video streams that are highly complex, e.g., with large numbers of active objects and/or entropy, can be processed to generate reduced-dimensionality semantic representations, such as natural language descriptions, of meaningful and/or useful scope.

In some implementations, a method may include: analyzing a natural language input; based on the analyzing, determining a semantic scope to be imposed on a natural language description that is to be formulated based on a temporal sequence of digital images; processing the temporal sequence of digital images based on one or more machine learning models to identify one or more candidate features that fall within the semantic scope, whereby one or more other features that fall outside of the semantic scope are disregarded; and formulating the natural language description to describe one or more of the candidate features.

In various implementations, the semantic scope may include an object category, and the one or more candidate features may include one or more candidate objects detected in the temporal sequence of digital images that are classified in the object category using one or more of the machine learning models. In various implementations, the method may further include determining a distance between a first embedding generated from the object category and one or more additional embeddings generated from the one or more detected candidate objects.

In various implementations, the semantic scope may include an action category, and the one or more candidate features may include one or more candidate actions, captured in the temporal sequence of digital images that are classified in the action category using one or more of the machine learning models. In various implementations, the method may further include determining a distance between a semantic scope embedding generated from the natural language input and a semantic action embedding generated from a sub-sequence of digital images of the temporal sequence of digital images, wherein the subsequence of digital images portray one of the candidate actions. In various implementations, the method may further include: determining that a given candidate action of the one or more candidate actions was identified with a measure of confidence that fails to satisfy a threshold; and in response to the determining, formulating a natural language prompt for the user, wherein the natural language prompt solicits the user for a kinematic demonstration of the given candidate action.

In various implementations, the method may further include: determining that a given candidate feature of the one or more candidate features was identified with a measure of confidence that fails to satisfy a threshold; and in response to the determining, formulating a natural language prompt for the user, wherein the natural language prompt solicits confirmation of whether the given candidate feature falls within the semantic scope provided by the user in the natural language input. In various implementations, the method may further include training one or more of the machine learning models based on a response from the user to the natural language prompt.

In various implementations, the method may further include conditioning one or more of the machine learning models based on the natural language input received from the user.

In various implementations, the determining may include generating a semantic scope embedding based on the natural language input. In various implementations, the one or more candidate features may be identified based on one or more respective distances between the semantic scope embedding and one or more semantic feature embeddings generated based on the one or more candidate features.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 schematically depicts an example environment in which selected aspects of the present disclosure may be employed in accordance with various implementations.

FIG. 2 schematically depicts an example of how natural language inputs may be mapped to semantic scope embeddings that represent objects, entities, and/or actions in a video feed, in accordance with various implementations.

FIG. 3 schematically depicts components and a pipeline for practicing selected aspects of the present disclosure, in accordance with various implementations.

FIG. 4 is a flowchart of an example method in accordance with various implementations described herein.

FIG. 5 schematically depicts an example architecture of a computer system.

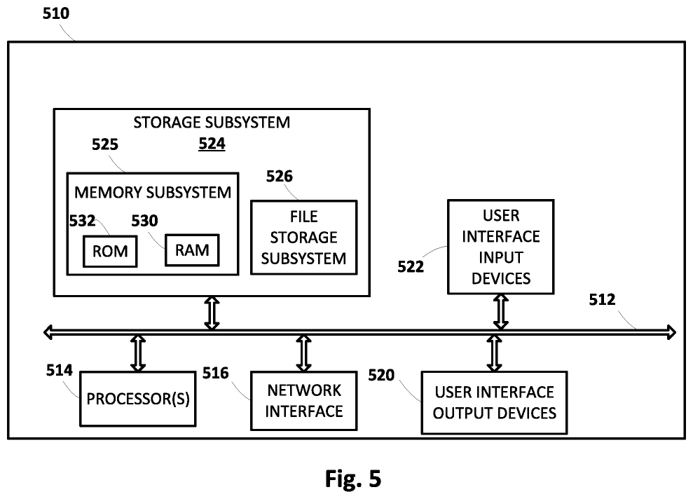

### DETAILED DESCRIPTION

Temporal sequences of digital images may take various forms, and may or may not include other modalities of output, such as sound, haptic feedback, etc. Temporal sequences of digital images may include, for instance, various types of video feeds, such as close-circuit television (CCTV), video captured using a digital camera (e.g., of a phone, of a web-enabled camera, a security camera), and so forth. In some cases, analog video such as film may be converted to digital to form a temporal sequence of digital images. While the term “video feed” is used herein to describe various examples, temporal sequences of digital images are not limited to video feeds. For example, one or more cameras may capture sequences of images at lower frequencies/framerates (e.g., five or ten frames per minute) than would be typically referred to as a video feed (e.g., 26 frames per second).

“Features” of temporal sequences of digital images may include any object, entity, or action that is perceivable in a temporal sequences of digital images. As used herein, an “object” may broadly refer to any object that can be acted upon by an entity. Objects may include, but are not limited to, fluids, construction materials, tools, toys, rubbish, buildings, machinery (which can also be an entity in some circumstances), electronic devices, furniture, dishware, yard waste, food, drinks, appliances, and so forth.

An “entity” may be any living or non-living thing that is capable of performing, or being operated to perform, an action, e.g., on an object or otherwise. Entities may include, but are not limited to, people, animals, insects, plants (over a time window that is typically longer than other entities), robots, machinery (e.g., heavy machinery such as construction machinery), and so forth. It should be understood that objects and entities are not mutually exclusive; for instance, an excavator without an operator may be more like an object than an entity.

An “action” can include any act performed by or via an entity, on an object, on another entity, or otherwise. People, many animals, and even some robots may be capable of performing acts such as walking, running, lifting, swimming, jumping, sitting, digging, carrying, pushing, pulling, speaking, operating another entity (e.g., a machine), and so forth. Machinery and/or robots may be capable of performing, or being operated to perform, acts such as digging, moving, lifting, pouring, planting, applying chemicals, assembling, and so forth. Whereas objects and entities can be detected in a single frame of a video feed, actions may be detected across multiple frames of a video feed.

In various implementations, a user who wishes to summarize some, but not all, content portrayed in a video stream may provide natural language input that conveys a desired semantic scope. This desired semantic scope may be imposed (directly or indirectly) on a natural language description that is to be formulated based on a temporal sequence of digital images, such as a video stream. When the temporal sequence of digital images is processed, e.g., using one or more machine learning models, one or more candidate features (e.g., objects, entities, actions) that fall within the semantic scope (e.g., with a threshold measure of confidence) may be identified. Feature(s) that clearly fall outside of the semantic scope may be disregarded. In some implementations, for features that do not squarely fall within or outside of the semantic scope, the user may be solicited for confirmation of whether the feature falls within the semantic scope.

In some implementations, the natural language input may be converted into a form that is capable of being processed by a computing system, such as semantic scope embedding. In various implementations, this semantic scope embedding may represent a coordinate in a semantic scope space (e.g., a latent or embedding space) that includes embeddings generated from other natural language snippets, including natural language inputs that conveyed desired semantic scopes. In various implementations, mappings between this semantic scope space and other spaces associated with other domains (e.g., related to features found in still images and/or video feeds) may be learned, e.g., by training one or more machine learning models, and used to translate between natural language and these other domains.

Semantic (or embedding) spaces of other domains may also be learned. Some of these semantic spaces may be learned specifically for purposes of summarizing video feeds. For example, a semantic action space may be learned at least in part by training machine learning model(s) using training data in the form of user-provided natural language curations of video feeds. Other semantic spaces may be learned for other, unrelated purposes (e.g., object recognition), and may be leveraged for purposes of summarizing video feeds. In any case, mappings between these other domains may be learned in addition to mappings to the semantic scope space. These other domains may vary widely, and may include for instance, object, entity, and/or action recognition in particular subject areas (e.g., biology, zoology, construction, robotics, retail, security, etc.).

In various implementations, mappings between various disparate domains may be learned at least in part using natural language training examples. For example, techniques exist for identifying objects depicted in a scene of a video. In various implementations, users may provide, as natural language training data, commentary that describes actions that occur in association with these objects. This natural language training data can be used to learn mappings between these identified objects and those actions.

Techniques described herein give rise to various technical advantages. Being able to limit the scope of what is summarized from a complex or busy video feed (e.g., of a large store or construction site) may enable users to eliminate noise (e.g., objects, entities, and/or actions that are not of interest) and focus on what they are interested in. For example, a store owner can request that description of surveillance video be focused on particular products that are highly valuable and/or frequently stolen. As another example, a construction site manager may request textual summaries of heavy machinery activity, to the exclusion of activities of individual workers. As another example, a user could request that their front door camera video feed provide textual descriptions of persons other than postal personnel or known family members who appear on a front porch.

In addition, by reducing video feeds to reduced-dimensionality semantic representations such as textual summarizations/descriptions, the video feeds themselves can be deleted and/or overwritten, conserving considerable memory and other computer resources. Moreover, reduced-dimensionality semantic representations may be formulated to exclude information that may be deemed private or personal. For example, identities of people depicted in videos may not be preserved—instead, people may be described in general or anonymized terms, such as “person,” “man,” “woman,”, “child,” “police,” “worker,” “doctor,” “nurse,” etc. Accordingly, the underlying video feed, which may contain information that is usable to identify individuals, can be erased or overwritten, so that only the anonymized video description remains.

In many examples described herein, video feeds are described as being reduced to textual summaries or descriptions, but this is not meant to be limiting. In various implementations, other types of reduced-dimensionality semantic representations may be used, e.g., in addition to or instead of textual descriptions/summaries. In some cases, these other representations may be used as intermediate representations between video feeds and natural language descriptions, although this is not required. As an example, suppose a video feed depicts an athletic context, such as a football match, a basketball game, a tennis match, etc. A more structured reduced-dimensionality semantic representation may be created based on the video feed and any user-provided semantic scope. This more structured representation may take the form of, for instance, a box score having a level of detail that corresponds to the user-provided semantic scope. In other contexts, such as a construction site, the structured representation may be formed as a list of operations performed by various entities. In many cases, these reduced-dimensionality semantic representations may be readily converted into natural language, e.g., using heuristics, rules, machine learning, etc.

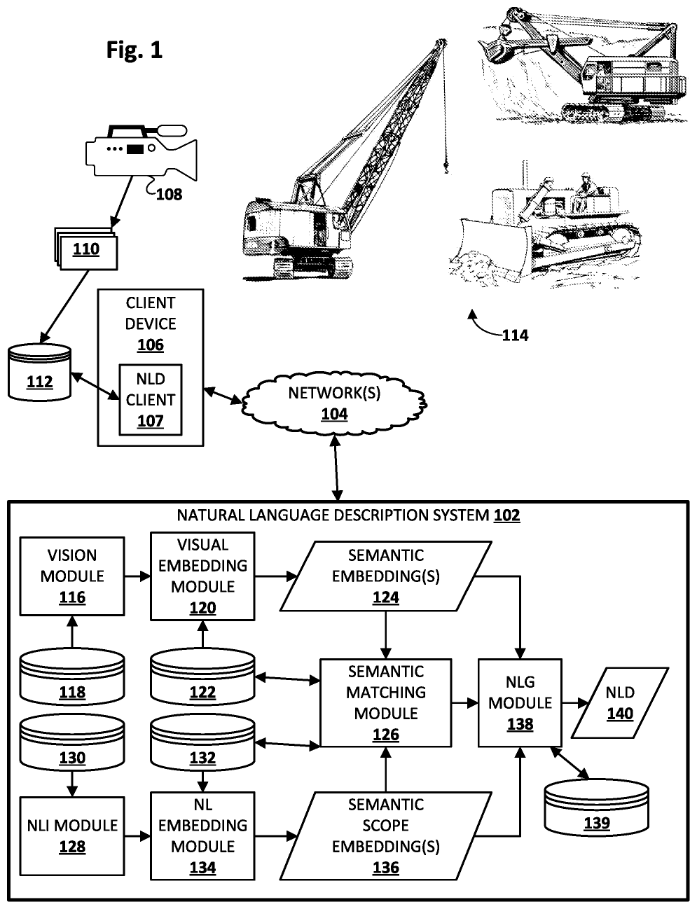

FIG. 1 schematically illustrates an environment in which one or more selected aspects of the present disclosure may be implemented, in accordance with various implementations. The example environment includes one or more surveilled areas 114 and various components that may be implemented near surveilled area 114 or elsewhere, in order to practice selected aspects of the present disclosure. Various components in the environment are in communication with each other over one or more networks 104. Network(s) 104 may take various forms, such as one or more local or wide area networks (e.g., the Internet), one or more personal area networks (“PANs”), one or more mesh networks (e.g., ZigBee, Z-Wave), etc.

A natural language description system 102 may be configured with selected aspects of the present disclosure to process a temporal sequence of digital images 110 in order to generate natural language descriptions/summaries (140) of visual events that are depicted in the temporal sequence of digital image 110. Temporal sequence of digital images 110 may take various forms, such as a video feeds, a subset of selected frames of a video feed, images captured at a lower frequency or framerate than is usually attributed to a video feed (e.g., one image captured every five or ten seconds), and so forth. Temporal sequence of digital images 110 may be captured by one or more cameras 108, such as a digital camera, a closed-circuit television (CCTV) camera, a digital camera deployed for surveillance, and so forth. In other implementations, vision data captured by other types of vision sensors, such as infrared sensors, X-ray sensors, laser-based sensors (e.g., LIDAR), etc., may be processed and summarized using techniques described herein.

An individual (which in the current context may also be referred to as a “user”) may operate a client device 106 to interact with other components depicted in FIG. 1. A client device 106 may be, for example, a desktop computing device, a laptop computing device, a tablet computing device, a mobile phone computing device, a computing device of a vehicle of the participant (e.g., an in-vehicle communications system, an in-vehicle entertainment system, an in-vehicle navigation system), a standalone interactive speaker (with or without a display), or a wearable apparatus that includes a computing device, such as a head-mounted display (“HMD”) that provides an AR or VR immersive computing experience, a “smart” watch, and so forth. Additional and/or alternative client devices may be provided.

Natural language description system 102 is an example of an information system in which the techniques described herein may be implemented. Each of client devices 106 and natural language description system 102 may include one or more memories for storage of data and software applications, one or more processors for accessing data and executing applications, and other components that facilitate communication over a network. The operations performed by client device 106 and/or natural language description system 102 may be distributed across multiple computer systems. In some implementations, natural language description system 102 may be implemented across one or more computing systems that may be referred to as the “cloud.”

Client device 106 may operate a natural language description (NLD) client 107 (e.g., which may be standalone or part of another application, such as part of a web browser) that enables a user to generate, review, manipulate, and/or otherwise interact with natural language descriptions generated using techniques described herein. In some implementations, NLD client 107 may be a standalone application. In other implementations, NLD client 107 may be an integral part (e.g., a feature or modular plug in) of another application, such as an application that allows a user to view and/or control surveillance equipment, an application that allows to a user to view and/or monitor a workplace, such as factory floor, construction site, medical facility, and so forth.

Natural language description system 102 may include a variety of different components that cooperate and/or are leveraged to implement selected aspects of the present disclosure. In FIG. 1, for instance, natural language description system 102 includes a vision module 116, a visual embedding module 120, a semantic matching module 126, a natural language input (NLI) module 128, a natural language (NL) embedding module 134, and a natural language generation (NLG) module 138. One or more of modules 116, 120, 126, 128, 134, and/or 138 may be combined with others, may be omitted, and/or may be implemented separately from natural language description system 102.

Vision module 116 may be configured to obtain temporal sequences of digital images such as 110 from various sources, such as one or more cameras 108 or NLD client 107, and may store those temporal sequences in a database 118, at least temporarily. In some implementations, temporal sequence of digital images 110 may be encrypted, e.g., by NLD client 107 using a public key provided by natural language description system 102 to NLD client 107, prior to being uploaded to database 118. In some such implementations, vision module 116 may include a private key or other security credential that allows it to decrypt temporal sequence of digital images 110 in order that downstream components can practice selected aspects of the present disclosure to generate natural language description(s) (NLD) 140 of objects, entities, and/or actions that are depicted in temporal sequence of digital images 110. These natural language descriptions 140 may be generated in a manner such that identities and/or other potentially private information contained in temporal sequence of digital images 110 is excluded or scrubbed. In some such implementations, temporal sequence of digital images 110 may only be available in unencrypted form at a worksite or other location at which client device 106 is deployed, thereby preserving privacy.

Visual embedding module 120 may be configured to process temporal sequence of digital images 110 provided (and decrypted, if applicable) by vision module 116 to generate semantic embeddings 124. Semantic embeddings 124 may include any reduced-dimensionality representation of an object, entity, or action that is portrayed in temporal sequence of digital images 110. For example, an entity such as a crane that is present at surveilled area 114 may be identified in one or more frames of temporal sequence of digital images 110, e.g., using a convolutional neural network (CNN) stored in a visual machine learning model database 122 or using one or more other object recognition techniques. The visual state of this crane, as depicted in the individual digital images of temporal sequence of digital images 110, may change over time as the crane is operated to perform one or more actions. These changes in state over time may be encoded into semantic embedding(s) 124, e.g., along with data indicative of the recognized entity.

Natural language input (NLI) module 128 may be configured to process audio data captured at one or more microphones (not depicted, e.g., of client device 106) and/or stored in a database 130 and perform speech recognition processing to generate textual natural language input. This textual natural language input may be provided to natural language (NL) embedding module 132. In other implementations, NLD client 107 may perform speech recognition on user utterances, and that speech recognition output may be provided to natural language description system 102.

Natural language embedding module 134 may be configured to process the textual natural language input using one or natural language processing machine learning models stored in a textual machine learning model database 132 to generate one or more semantic scope embeddings 136 that capture the semantics of the natural language input—and particularly, the scope of what the user wishes to summarize in a temporal sequence of digital images—in a reduced dimensionality form. These natural language process machine learning models may take various forms. In some implementations, these machine learning models may take the form of encoder portions of encoder-decoder networks. Additionally or alternatively, in some implementations, these machine learning models may take the form of one or more recurrent neural networks, such as a long short-term memory (LSTM) and/or gated recurrent unit (GRU) network. Additionally or alternatively, in some implementations, these natural language processing machine learning models may include a transformer module generated in accordance with Bidirectional Encoder Representations from Transformers (BERT).

In some implementations, including that depicted in FIG. 1, a semantic matching module 126 may be configured to match one or more semantic embeddings 124 that represent one or more objects, entities, and/or actions portrayed in temporal sequence of digital images 110 to semantic scope embedding 136. For example, if the user's request was, “tell me how the heavy machinery was used,” then only those portrayed objects, entities, and/or actions that are semantically related to “heavy machinery” will be matched. As another example, the user's request was, “summarize the activity of the robotic forklifts,” then only those portrayed objects, entities, and/or actions that are semantically-related to “robotic forklifts” will be matched.

Semantic matching module 126 may match semantic embeddings 124 generated from visual data (e.g., 110) to semantic scope embeddings 136 in various ways. In some implementations, semantic matching module 126 may have access to function(s) (e.g., in one of the machine learning model databases 122, 132) that translate between a visual embedding space containing semantic embeddings 124 of objects, entities, and/or actions and a semantic scope and/or natural language embedding space that contains semantic scope embeddings 136. These function(s) may take various forms, such as trained machine learning models, including but not limited to neural networks, transformers, support vector machines, etc. In some implementations, a machine learning model may be jointly trained on visual semantic embeddings 124 and semantic scope embeddings 136, effectively creating a joint embedding space.

In some implementations, the semantic scope provided in the user's natural language input may be used differently than what is depicted in FIG. 1. For example, instead of visual embedding module 120 processing all detectable objects, entities, and/or actions portrayed in temporal sequence of digital images 110, semantic scope embedding(s) 136 may be used by visual embedding module 120 to select which machine learning model(s) it will apply. This may reduce the use of computational resources and speed up performance of the overall pipeline.

Natural language generation (NLG) module 138 may be configured to process the semantic embeddings 124 matched to semantic scope embeddings 136 by semantic matching module 136 to generate a natural language description (NLD) 140 of event(s) associated with object(s), entities, and/or actions that are portrayed in temporal sequence of digital images 110 and that fall within the user-provided semantic scope. In some implementations, natural language generation module 138 may use one or more machine learning models stored in a database 139 to generate the natural language description. These machine learning models may take various forms, such as decoder portions of encoder-decoder networks that have been trained, for instance, using training data in the form of user-provided curations of observed video feeds.

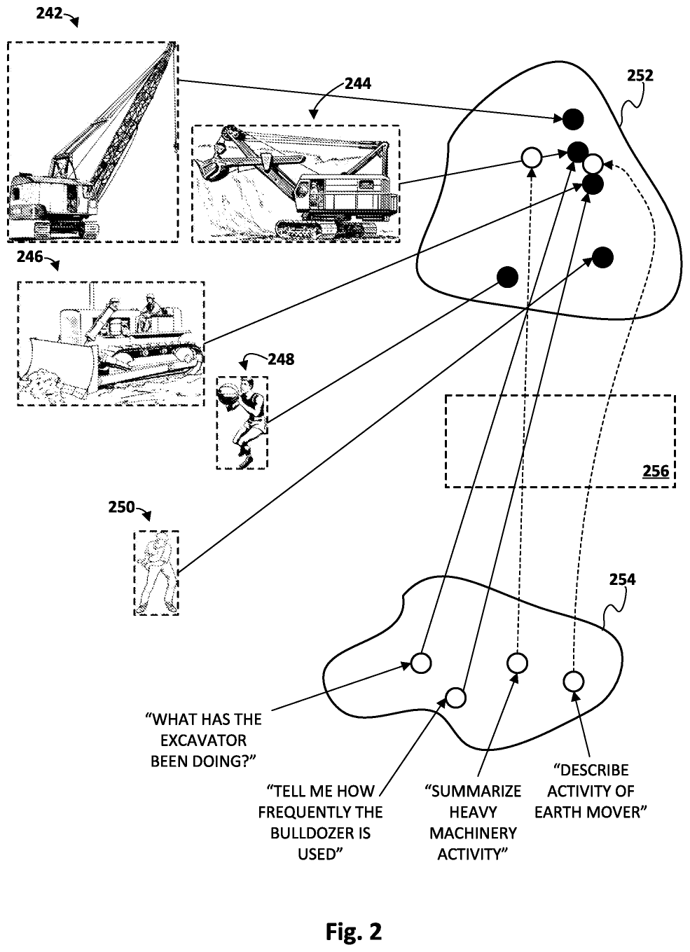

FIG. 2 schematically depicts one example of how aspects of visual data (e.g., temporal sequence of digital images 110) and textual data, such as natural language inputs provided by users to convey a desired scope of video textual description, may be mapped to various embedding spaces. FIG. 2 also schematically depicts how these embedding spaces may in turn be mapped to each other, so that selected aspects of the present disclosure may be practiced. In this example, it is assumed that one or more cameras (not depicted) are capturing a video feed of a construction site.

A plurality of entities 242-250 have been identified, e.g., by visual embedding module 120 performing object recognition processing on frames of the video feed (e.g., 110). These entities include a crane 242, an excavator 244, a bulldozer 246, a first person 248 not currently engaged with construction-related activity (e.g., a worker on break playing basketball), and a second person 250 that is currently engaged in construction-related activity. As indicated by the arrows, these detected entities have been mapped as embeddings (black circles) in a visual embedding space 252. While depicted in FIG. 2 in two dimensions for illustrative purposes, it should be understood that embedding spaces described herein may have as many dimensions as there are dimensions in the underlying embeddings.

It can be seen that the heavy machinery 242-248 have embeddings in visual embedding space 252 that are clustered more closely together than they are with other embeddings. In addition, the embedding generated from first person 248 is farther away from all the other embeddings (e.g., an outlier) because that person is not currently engaged in construction-related activity. By contrast, the embedding generated from second person 250 is at least somewhat closer to the embeddings generated from the heavy machinery (242-248) because second person 250 is currently engaged in construction-related activity.

Depicted at bottom of FIG. 2 are a plurality of natural language inputs that each provide some desired semantic scope for generating descriptions of video feeds. For example, a first natural language input asks, “what has the excavator been doing?” This natural language input clearly represents an intent to generate a natural language description of the video feed that summarizes activity of excavator 244, e.g., to the exclusion of other entities in the construction site. These natural language inputs have been mapped, e.g., by natural language embedding module 134, to embeddings (white circles) in a natural language/semantic scope embedding space 254.

In this example, a function 256 maps (e.g., by virtue of having weights that have been trained) the embeddings of natural language/semantic scope embedding space 254 to visual embedding space 252. As might be expected, the embedding of natural language input, “what has the excavator been doing” is mapped via function 256 to the embedding in visual embedding space 252 that represents excavator 244. Similarly, the embedding of natural language input, “tell me how frequently the bulldozer is used,” is mapped via function 256 to the embedding in visual embedding space 252 that represents bulldozer 246.

Function 256 may not map other embeddings in natural language/semantic scope embedding space 254 so directly to embeddings contained in visual embedding space 252. For example, the embedding that represents the natural language input, “describe activity of earth mover,” is mapped to an embedding (white circle) in visual embedding space 252 that is near, but does not exactly coincide with, the embeddings representing excavator 244 and bulldozer 246. This may be because the term “earth mover” is somewhat ambiguous and can refer to one or both of excavator 244 and bulldozer 246, as either entity is operable to move earth. Thus, in some implementations, a natural language description that is generated based on this natural language input may describe the activity of both excavator 244 and bulldozer 246. Additionally or alternatively, in some implementations, given the ambiguity, the user may be provided with a prompt (e.g., visually or audibly) that solicits clarification of the term, “earth mover.” The user's response to such a prompt may be used in some cases to continue the training of function 256.

As another example, the embedding in embedding space 254 representing the natural language input, “summarize heavy machinery activity,” may not be mapped by function 256 directly to any one embedding in visual embedding space 252. Rather, function 256 maps this embedding to a white circle in visual embedding space that lies more or less equidistant from the embeddings representing heavy machinery 242-246. Thus, generating a natural language description for a video feed based on this semantic scope may include summarizing the activities of all three entities.

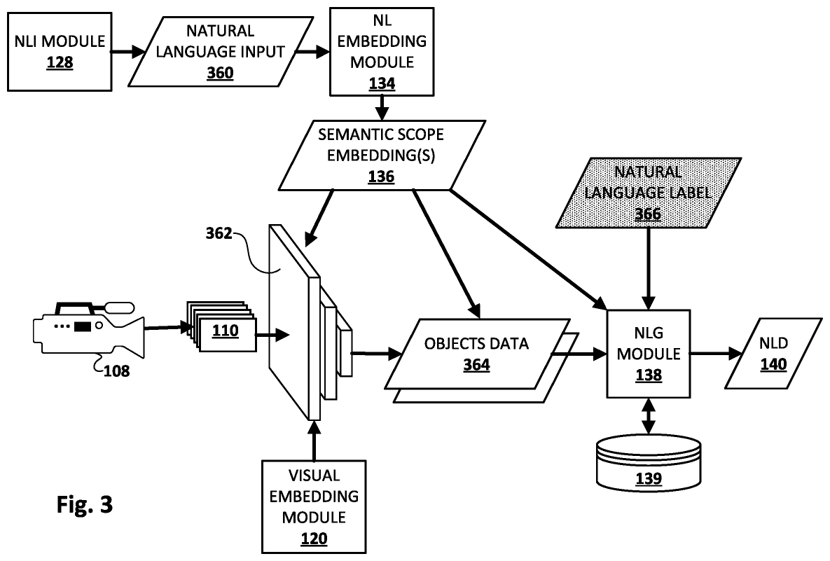

FIG. 3 schematically depicts an example pipeline of components that may be operated to generate a natural language description (NLD) 140 of a temporal sequence of digital images 110 captured by a camera 108. An utterance containing a user's desired scope is received at one or more microphones (not depicted) and is processed by natural language input module 128 to generate a textual natural language input 360. Textual natural language input 360 may be provided to natural language embedding module 134.

Natural language embedding module 134 generates one or more semantic scope embeddings 136 that represent the semantic scope of natural language description requested by the user. In various implementations, semantic scope embedding(s) 136 may be used, e.g., by visual embedding module 120, to select one or more machine learning models, such as one or more convolutional neural networks (CNN) 362, to process temporal sequence of digital images 110. The output of CNN(s) 362 may or may not include semantic embedding(s) 124 (see FIG. 1) and/or objects data 364. Objects data 364 may include, for instance, a list of objects, entities, and/or actions detected in temporal sequence of digital images 110 based on output of CNN(s) 362. In some implementations, objects data 364 may take the form of a scene description markup language that may or may not be hierarchically structured.

In some implementations, semantic scope embedding(s) 136 may be used to select and/or filter particular objects/entities/actions from objects data 364, in addition to or instead of being used by visual embedding module 120 to select one or more CNN(s) 362. And in some implementations, semantic scope embedding(s) 136 may be used by natural language generation module 138 as well, e.g., as additional input to a machine learning model that is used to generate natural language description 140. In various implementations, the objects/entities/actions that fall within the semantic scope represented by semantic scope embedding(s) 136 may be processed by natural language generation module 138 using machine learning models (e.g., decoder portions of encoder-decoder networks stored in database 139) to generate natural language description 140.

In some implementations, during training of natural language generation module 138, natural language label(s) 366 may be provided, e.g., by people watching temporal sequence of digital images 110. These natural language label(s) 366 may describe aspects of what is being portrayed in temporal sequence of digital images 110. For example, a person may observe and transcribe (orally, in writing) the various action(s) being performed by entities on various objects and/or other entities. These labels may then be compared with the natural language description(s) 140 generated by natural language generation module 138. To the extent there is a difference, or error between the labels 366 and natural language description 140, techniques such as back propagation and gradient descent may be used to train natural language generation module 138, which as noted previously may be a decoder portion that is trained to map semantic embeddings 124 and/or object data 366 to natural language. Thus, the natural language label(s) 366 may serve as “verbiage” that connects otherwise static objects and/or entities identified in objects data 364 to action(s). Block 366 is shaded to indicate that during inference, label(s) 366 may be omitted.

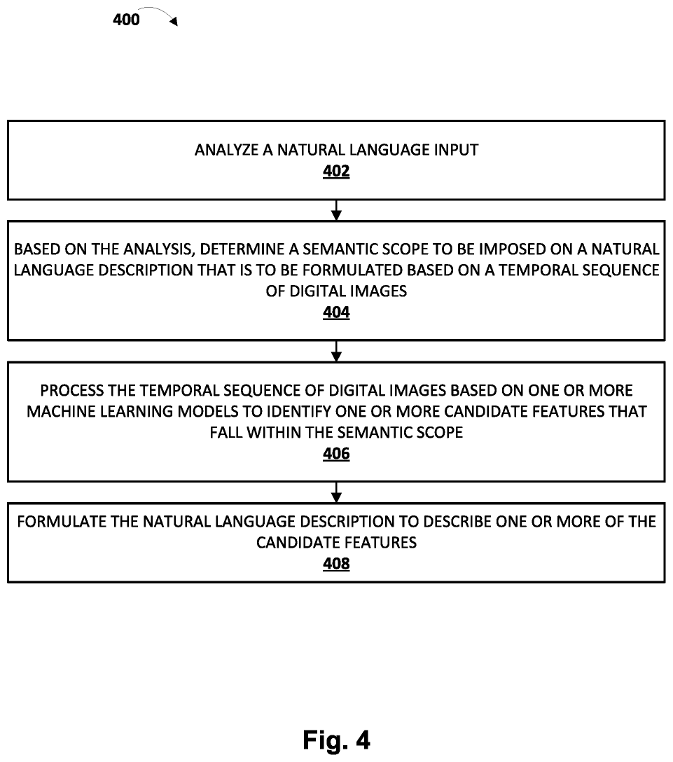

FIG. 4 illustrates a flowchart of an example method 400 for practicing selected aspects of the present disclosure. The operations of FIG. 4 can be performed by one or more processors, such as one or more processors of the various computing devices/systems described herein, such as by natural language description system 102. For convenience, operations of method 400 will be described as being performed by a system configured with selected aspects of the present disclosure. Other implementations may include additional operations than those illustrated in FIG. 4, may perform step(s) of FIG. 4 in a different order and/or in parallel, and/or may omit one or more of the operations of FIG. 4.

At block 402, the system, e.g., by way of natural language input module 128 and/or natural language embedding module 134, may analyze a natural language input. Based on the analyzing of block 402, at block 404, the system may determine a semantic scope to be imposed on a natural language description (e.g., 140) that is to be formulated based on a temporal sequence of digital images (e.g., 110).

At block 406, the system, e.g., by way of visual embedding module 120 and semantic matching module 126, may process the temporal sequence of digital images based on one or more machine learning models (e.g., CNN(s) 362) to identify one or more candidate features that fall within the semantic scope. One or more other features that fall outside of the semantic scope may be disregarded (e.g., ignored, or not processed by virtue of applicable CNN(s) not being selected to begin with).

In some implementations, the semantic scope may correspond to an object category, such as heavy machinery, medical equipment, robots, merchandise deemed to be particularly valuable and/or highly likely to be stolen, etc. The one or more candidate features may include one or more candidate objects detected in the temporal sequence of digital images that are classified in the object category using one or more of the machine learning models. For example, a distance may be determined in embedding space (e.g., a joint embedding space that includes embeddings of both visual data and natural language) between a first embedding generated from the object category and one or more additional embeddings generated from the one or more detected candidate objects. Candidate objects with embeddings that are beyond some threshold distance from the embeddings underlying the object categories may trigger a prompt for the user seeking confirmation of whether those candidate objects fall within the user's desired semantic scope.

In some implementations, the semantic scope may be an action category. In some such implementations, the one or more candidate features may include one or more candidate actions, captured in the temporal sequence of digital images, that are classified in the action category using one or more of the machine learning models. For example, a distance may be determined between a semantic scope embedding generated from the natural language input and a semantic action embedding generated from a sub-sequence of digital images of the temporal sequence of digital images. The subsequence of digital images may portray one of the candidate actions.

In some implementations, the system may determine that a given candidate object, entity, and/or action was identified with a measure of confidence that fails to satisfy a threshold. For example, an embedding generated from the observed action may not be sufficiently proximate to embedding(s) corresponding to known actions in an action embedding space. In such a scenario, a natural language prompt may be formulated for the user. The natural language prompt may solicit the user for additional information, such as confirmation of whether the detected action falls within the user's provided semantic scope, a kinematic demonstration of the given candidate action (e.g., an animation of the action being performed, a video clip of the action being performed, etc.), and so forth. In some implementations, one or more of the machine learning models may be trained further based on a response from the user to the natural language prompt.

At block 408, the system, e.g., by way of natural language generation module 138, may formulate the natural language description to describe one or more of the candidate features. This natural language description may then be used for various purposes. For example, the temporal sequence of digital images may be deleted, or encrypted and stored away, and the natural language description only may be made available to interested parties (e.g., those without sufficient privileges). Additionally or alternatively, in some implementations, the natural language description may be preserved, so that if an underlying video stream is later altered, e.g., to include so-called “deep fakes,” the preserved natural language description can be used to verify the original content of the video stream.

In some implementations, natural language descriptions may be used as a feedback mechanism that controls what portion(s) of a video feed is recorded (or preserved) in the first place. For example, a video feed may be stored in a temporary buffer (e.g., a ring buffer) by default. Video data stored in this buffer may be continuously analyzed using techniques described herein to generate a running natural language description. Based on this running natural language description, if an event that falls within a semantic scope provided by the user is detected in the video feed, the video feed may then be diverted or split into different, longer-term computer memory (e.g., a hard disk, a server, cloud storage, etc.). This longer-term memory may be accessible by interested parties to view these preserved portions of video feeds. Meanwhile, portions of the original video feed that do not depict events that fall within the user-provided semantic scope are deleted or overwritten in the temporary buffer.

As an example, a store manager could request that only video showing people interacting with a particular product be recorded. Video data depicting any other activity in the store may only be stored temporarily in the buffer, and then deleted/overwritten, without being preserved for future use, because it does not show people interacting with the particular product. Selectively recording and/or preserving raw video data in this way may conserve memory resources and/or network resources.

FIG. 6 is a block diagram of an example computing device 610 that may optionally be utilized to perform one or more aspects of techniques described herein. Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616.

The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In some implementations in which computing device 610 takes the form of a HMD or smart glasses, a pose of a user's eyes may be tracked for use, e.g., alone or in combination with other stimuli (e.g., blinking, pressing a button, etc.), as user input. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, one or more displays forming part of a HMD, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of method 400 described herein, as well as to implement various components depicted in FIGS. 1 and 2.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors and comprising:
analyzing a natural language input;
based on the analyzing, determining a semantic scope to be imposed on a natural language description that is to be formulated based on a temporal sequence of digital images;
processing the temporal sequence of digital images based on one or more machine learning models to identify one or more candidate features that fall within the semantic scope, whereby one or more other features that fall outside of the semantic scope are disregarded; and
formulating the natural language description to describe one or more of the candidate features.

2. The method of claim 1, wherein semantic scope comprises an object category, and the one or more candidate features comprise one or more candidate objects detected in the temporal sequence of digital images that are classified in the object category using one or more of the machine learning models.

3. The method of claim 2, further comprising determining a distance between a first embedding generated from the object category and one or more additional embeddings generated from the one or more detected candidate objects.

4. The method of claim 1, wherein semantic scope comprises an action category, and the one or more candidate features comprise one or more candidate actions, captured in the temporal sequence of digital images that are classified in the action category using one or more of the machine learning models.

5. The method of claim 4, further comprising determining a distance between a semantic scope embedding generated from the natural language input and a semantic action embedding generated from a sub-sequence of digital images of the temporal sequence of digital images, wherein the subsequence of digital images portray one of the candidate actions.

6. The method of claim 4, further comprising:
determining that a given candidate action of the one or more candidate actions was identified with a measure of confidence that fails to satisfy a threshold; and
in response to the determining, formulating a natural language prompt for the user, wherein the natural language prompt solicits the user for a kinematic demonstration of the given candidate action.

7. The method of claim 1, further comprising:
determining that a given candidate feature of the one or more candidate features was identified with a measure of confidence that fails to satisfy a threshold; and
in response to the determining, formulating a natural language prompt for the user, wherein the natural language prompt solicits confirmation of whether the given candidate feature falls within the semantic scope provided by the user in the natural language input.

8. The method of claim 7, further comprising training one or more of the machine learning models based on a response from the user to the natural language prompt.

9. The method of claim 1, further comprising conditioning one or more of the machine learning models based on the natural language input received from the user.

10. The method of claim 1, wherein the determining includes generating a semantic scope embedding based on the natural language input.

11. The method of claim 10, wherein the one or more candidate features are identified based on one or more respective distances between the semantic scope embedding and one or more semantic feature embeddings generated based on the one or more candidate features.

12. A system comprising one or more processors and memory storing instructions that, in response to execution of the instructions by the one or more processors, cause the one or more processors to:
analyze a natural language input;
based on the analysis, determine a semantic scope to be imposed on a natural language description that is to be formulated based on a temporal sequence of digital images;
process the temporal sequence of digital images based on one or more machine learning models to identify one or more candidate features that fall within the semantic scope, whereby one or more other features that fall outside of the semantic scope are disregarded; and
formulate the natural language description to describe one or more of the candidate features.

13. The system of claim 12, wherein semantic scope comprises an object category, and the one or more candidate features comprise one or more candidate objects detected in the temporal sequence of digital images that are classified in the object category using one or more of the machine learning models.

14. The system of claim 13, further comprising instructions to determine a distance between a first embedding generated from the object category and one or more additional embeddings generated from the one or more detected candidate objects.

15. The system of claim 12, wherein semantic scope comprises an action category, and the one or more candidate features comprise one or more candidate actions, captured in the temporal sequence of digital images that are classified in the action category using one or more of the machine learning models.

16. The system of claim 15, further comprising determining a distance between a semantic scope embedding generated from the natural language input and a semantic action embedding generated from a sub-sequence of digital images of the temporal sequence of digital images, wherein the subsequence of digital images portray one of the candidate actions.

17. The system of claim 15, further comprising instructions to:
determine that a given candidate action of the one or more candidate actions was identified with a measure of confidence that fails to satisfy a threshold; and
in response to the determination, formulate a natural language prompt for the user, wherein the natural language prompt solicits the user for a kinematic demonstration of the given candidate action.

18. The system of claim 12, further comprising instructions to:
determine that a given candidate feature of the one or more candidate features was identified with a measure of confidence that fails to satisfy a threshold; and
in response to the determination, formulate a natural language prompt for the user, wherein the natural language prompt solicits confirmation of whether the given candidate feature falls within the semantic scope provided by the user in the natural language input.

19. The method of claim 18, further comprising instructions to train one or more of the machine learning models based on a response from the user to the natural language prompt.

20. At least one non-transitory computer-readable medium comprising instructions that, in response to execution of the instructions by one or more processors, cause the one or more processors to:
analyze a natural language input;
based on the analysis, determine a semantic scope to be imposed on a natural language description that is to be formulated based on a temporal sequence of digital images;
process the temporal sequence of digital images based on one or more machine learning models to identify one or more candidate features that fall within the semantic scope, whereby one or more other features that fall outside of the semantic scope are disregarded; and
formulate the natural language description to describe one or more of the candidate features.
